(19) United States
(12) Patent Application Publication
(10) Pub. No.: US 2014/0261974 A1
(43) Pub. Date: Sep. 18, 2014

(54) In-Line Tunnel Oven and Method for Treating Insulating Glass Units

(71) Applicant: SOUTHWALL TECHNOLOGIES, INC., Palo Alto, CA (US)

(72) Inventors: Richard T. Wipfler, Menlo Park, CA (US); Christian H. Stoessel, Santa Rosa, CA (US); Zhisheng Xiong, Chicago, IL (US)

(73) Assignee: SOUTHWALL TECHNOLOGIES, INC., Palo Alto, CA (US)

(21) Appl. No.: 13/831,188

(22) Filed: Mar. 14, 2013

(51) Int. Cl. E06B 3/673; F27B 9/12; F27B 9/30

(52) U.S. Cl. CPC E06B 3/6736; F27B 9/30; F27B 9/12
USPC 156/107; 432/128; 432/77

(57) ABSTRACT

A thermal treatment method for insulating glass units or IGUs having one or more suspended polymer films includes first curing a sealant at a first elevated temperature for a specified duration, then shrinking the suspended film at a second, higher, elevated temperature for a specified duration, and then cooling the IGUs back to ambient temperature. The various heating and cooling stages may be performed in a tunnel oven having different length sections at the desired temperatures, while the IGUs are conveyed from one section to the next.

### BACKGROUND

1. Field of the Invention

The present disclosure relates to systems and methods for the treatment of assembled multi-pane insulating glass units.

2. Description of the Related Art

As the cost of fossil fuels and other energy sources continues to rise and people become more concerned with the impact that energy generation has on the environment, there has been an increased interest in energy conservation. In particular, there is increased demand for products which themselves are not responsible for energy consumption, but which have an effect on the energy consumption of other devices.

For example, in architectural structures, the most energy demanding activity is generally climate control. Maintaining the interior temperature of a structure at a temperature comfortable for the average human in standard attire can be very energy intensive, whether through cooling or heating. Although the outside temperature in some climates is commonly within a desirable range such that climate control is inexpensive and not heavily used, there is a desire in most environments to alter the environment within a structure compared to the environment outside, at least for a portion of the year. Indeed, in some environments, the temperature differential between the inside of a structure and the outside environment can be large, with differences in temperature of 20° C. or more.

One of the best ways to control both the energy expended to alter the temperature and the energy expended to maintain a temperature in a structure is to properly insulate the structure. While not an active technology in most cases, insulation allows for the temperature differential inside and outside the structure to be maintained without as much infusion of energy. Good insulation is a barrier to heat transfer. Thus, less energy is required to maintain the temperature, and the temperature is more easily maintained in a particular range.

The science of insulated glass is well understood, and it is critical in high-performance building envelopes. The current state of the art is the use of multi-pane windows. These windows utilize multiple panes of glass, which are separated by air gaps, to provide for insulating structures without sacrificing transparency. The windows generally improve their insulating capacity through the simple addition of more glass panes. Double-pane windows provide good insulation while triple- or even quadruple-pane windows provide additional insulation. This technology can be combined with certain types of coatings for the panes to provide for additional spectral manipulation, including near-infrared reflection or transmission or thermal radiation characteristics. While these products work very well from an insulation perspective, they suffer from several major drawbacks.

Using more than two panes of glass in a window makes the window both significantly thicker and heavier. This, in turn, can make the windows more expensive to manufacture and to transport as well as making them unusable for some types of applications, such as large office towers. Thus, while double-pane windows have become nearly ubiquitous, triple-pane windows are rare and quadruple-pane windows are almost unheard of.

In order to deal with these concerns, U.S. Pat. No. 4,335,166 to Lizardo et al. describes a thermally insulating multi-pane glazing structure, known in the industry as an insulating glass unit (IGU), in which the interior pane is an interior glazing sheet such as a polyethylene terephthalate (PET) film. This film is suspended between outer, generally glass, panes and separated therefrom by spacers, with one embodiment describing the use of a heat-shrinkable film. This provides the structure of a triple-pane (or more) window while dramatically reducing the weight of the center pane(s) and, thus, the window's weight and thickness.

In order to assemble such a structure, it has generally been necessary to take the exterior panes (which are usually rigid), next attach spacer frames around the interior periphery of the panes with an adhesive, and then suspend the PET film between the two spacer rings. A primary sealant such as Polyisobutylene (PIB) may be placed between the film and the spacer as well as between the spacer and the glass to enhance durability and act as an assembly aid, as PIB is tacky and can temporarily fasten the film or glass to the spacer. A sealant is peripherally applied around the spacer frame to mechanically anchor the film, spacer frames, and glass panes. The interpane voids are then preferably filled with a low heat-transfer gas.

In order to provide for the aesthetics of a glass-like window structure when utilizing such an internal film and to maintain a prescribed cavity spacing, it is necessary for the film to be taut over the spacers. A taut film will generally not include wrinkles or waves. However, applying the film taut during assembly to the spacers and keeping it taut is generally impossible. In order to get the film in place and taut, the film is generally placed in a reasonably taut fashion, secured by the spacer and cured sealant system, and then thermally shrunk in place by heating the IGU. The heat makes the film taut. A common manufacturing technique accomplishes this by exposing the IGUs in a forced-air convective batch oven to a prescribed temperature sequence that cures the sealant and shrinks the film. This method suffers from limited production capacity, is labor-intensive, requires costly logistical infrastructure, utilizes resources inefficiently, wastes floor space, and is prone to accidents.

### SUMMARY

Because of these and other problems in the art, described herein is a method of treating an insulating glass unit (IGU) having a suspended film therein, comprising: (1) curing a sealant of the suspended film at a first elevated temperature for a specified first duration; (2) thermally shrinking the suspended film at a second elevated temperature greater than the first elevated temperature for a specified second duration; and (3) cooling the IGU to an ambient temperature in preparation for a gas fill of the IGU in a continuous and automated fashion.

The curing, shrinking, and cooling may take place within an in-line “tunnel” oven having distinct temperature zones. The heating may be accomplished by a re-circulating forced-air convective oven system. The tunnel oven has at least three distinct sections separated by gates, each of the sections dedicated to one of the respective curing, shrinking, and cooling steps. It may also include one or more preheat sections. The tunnel oven may thus include a first section that preheats an insulating glass unit to the first elevated temperature, a second section that holds the insulating glass unit at the first elevated temperature so as to cure a sealant within the specified first duration, a third section that preheats the insulating glass unit from the first to the second elevated temperature, a fourth section that holds the insulating glass unit at the second elevated temperature so as to shrink the suspended film, and a fifth section that cools the insulating glass unit to the ambient temperature.

The heat sealant may be, among other things, a polyurethane, silicone, or polysulfide sealant. The first elevated temperature may be in a range from 40° C. to 60° C., preferably 48° C. to 52° C., which is sufficient to cure certain sealants within 65 to 80 minutes. Other sealants may require different temperatures and durations but the temperature should generally not exceed 70° C. to 80° C. The suspended film may be a heat-shrinkable polyethylene terephthalate (PET) film. The second elevated temperature may be in a range from 90° C. to 110° C., preferably 98° C. to 102° C., which is sufficient to shrink the film in 20 to 55 minutes. The cooling of the IGU to ambient temperature may occur over a specified third duration of about 15 to about 30 minutes.

Also described herein is a method of treating an insulating glass unit having a suspended film therein, comprising: providing an insulating glass unit having a suspended film therein and a sealant thereon; raising a temperature of said glass unit to a first elevated temperature above an ambient temperature; maintaining said glass unit at said first elevated temperature for a sufficient time to cure said sealant; raising a temperature of said glass unit to a second elevated temperature above said first elevated temperature; maintaining said glass unit at said second elevated temperature for sufficient time to thermally shrink said suspended film to a point of being optically flat; and cooling the insulating glass unit to said ambient temperature.

In an embodiment of the method, the curing, shrinking and cooling take place within a tunnel oven having at least three distinct temperature zones.

In an embodiment of the method, the at least three distinct sections are separated by gates, and at least one of said at least three sections is maintained at said first elevated temperature and at least one of said at least three sections is maintained at said second elevated temperature. In an embodiment, the tunnel oven includes a first section that preheats an insulating glass unit to the first elevated temperature, a second section that holds the insulting glass unit at the first elevated temperature, a third section that preheats the insulating glass unit from the first to the second elevated temperature, a fourth section that holds the insulating glass unit at the second elevated temperature, and a fifth section that cools the insulating glass unit to the ambient temperature.

In an embodiment of the method, the sealant is a polyurethane sealant, a silicone sealant, or a polysulfide sealant.

In an embodiment of the method, the first elevated temperature is in a range from about 40° C. to about 60° C. and the specified first duration is about 65 to about 80 minutes.

In an embodiment of the method, the suspended film is a polyethylene terephthalate (PET) film.

In an embodiment of the method, the second elevated temperature is in a range from about 90° C. to about 110° C. and the specified second duration is about 20 to about 55 minutes.

In an embodiment of the method, the cooling to ambient temperature occurs over a specified third duration of about 15 to about 30 minutes.

In an embodiment of the method, the insulating glass unit is moved continuously through the steps of the method by a conveyor.

There is also provided herein a tunnel oven, comprising: a conveyor for transporting an insulating glass unit having a suspended film therein and a sealant thereon; a loading lobby for placing an insulating glass unit on said conveyor; said conveyor transporting said insulating glass unit through: a first section for raising a temperature of said glass unit to a first elevated temperature above an ambient temperature; a second section for maintaining said glass unit at said first elevated temperature for a sufficient time to cure said sealant; a third section for raising a temperature of said glass unit to a second elevated temperature above said first elevated temperature; a fourth section for maintaining said glass unit at said second elevated temperature for sufficient time to thermally shrink said suspended film to a point of being reflectively flat; a fifth section for cooling the insulating glass unit to said ambient temperature; and an exit lobby for removing said insulating glass unit from said conveyor.

In an embodiment of the tunnel oven, said second section is separated from said third section by a gate; and said fourth section is separated from said fifth section by a gate.

In an embodiment of the tunnel oven, a temperature in said first section and a temperature in said third section are established by heat moving into said first section and said third section from said second section.

In an embodiment of the tunnel oven, said temperature in said third section is also established by heat moving into said third section from said fourth section.

In an embodiment of the tunnel oven, said tunnel oven is about 24 to about 30 meters long.

In an embodiment of the tunnel oven, said insulating glass unit resides in said tunnel oven for about 2 to about 2.5 hours.

In an embodiment of the tunnel oven, said insulating glass unit resides in some combination of said first section and said second section for about 65 to about 80 minutes.

In an embodiment of the tunnel oven, said insulating glass unit resides in some combination of said third section and said fourth section for about 20 to about 55 minutes.

In an embodiment of the tunnel oven, said insulating glass unit resides in said fifth section for about 15 to about 30 minutes.

### BRIEF DESCRIPTION OF THE DRAWINGS

FIGS. 1A and 1B are perspective views of corner portions of insulating glass units (IGUs) with film suspended therein which may be heat treated using the systems and methods of the present application. In FIG. 1A, there is one suspended film and, in FIG. 1B, there are two suspended films.

FIG. 2 is a graph illustrating an embodiment of a time-temperature profile which may be used to perform a sealant cure, film shrink and cool down of an IGU.

FIG. 3 is a perspective view of an embodiment of a tunnel oven which can provide a time-temperature profile such as that of FIG. 2 to an IGU.

### DESCRIPTION OF PREFERRED EMBODIMENT(S)

FIG. 1A shows a cut-away corner of an insulating glass unit (IGU) (11) that has two or more transparent outer panes (13) and (15) that are separated by frame spacers (17) and (19) to minimize heat conduction. These outer panes (13) and (15) of the IGU are typically made from sheets of window glass but other rigid materials such as plastics can be used. A third intervening “pane” (21), separated by the frame spacers (17) and (19) from the outer panes (13) and (15), is formed of a thin flexible polymer film (21), such as polyethylene terephthalate (PET), so as to avoid significantly increasing the weight of the overall IGU (11) structure.

An infrared-reflecting coating could be formed on or applied to any one or more of the glass panes (13) and (15) or on one or both sides of the suspended polymer film (21). In order that the suspended film (21) be optically transparent, it is important that the film (21) be close to planar and not have any wrinkles, creases, or other imperfections which would be visible when looking at the IGU (11). In order to remove such imperfections, the film (21) is generally thermally tensioned by applying heat to the IGU (11) once it is assembled. The pair of cavities (23) defined between the outer panes and suspended film may then be filled with a low heat-transfer inert gas, such as argon or krypton, and hermetically sealed to provide for additional insulative characteristics.

While an adhesive, such as an adhesive tape, may be positioned between the spacers (17) and (19) and the glass panes (13) and (15) and the film (21) in order to hold these structures in place, this is often supplemented with an external sealant (25). The sealant (25) is often used both to provide for a much stronger seal to hold the film (21), spacers, and glass (13) and (15) securely in place and to seal the cavities (23) from the exterior environment to keep the internal gas within the cavities (23). The use of a sealant (25) can simplify construction as the film (21), when compared against the spacers, can be purposefully made too large to allow for easier positioning. The “tail” of the film (21) which can extend outside the structure of the spacers (17) and (19) can be at least partially captured in the sealant (25) (whether folded, wrinkled, or flat) to help hold the film (21) in place. In one embodiment, a polyurethane, silicone, or polysulfide sealant (25) is used around the spacers (17) and (19) to hold all of the elements together, to reduce leakage of the gas fill from the IGU (11), and to prevent moisture ingress. However, in other embodiments, other sealants (25) may be used as would be understood by one of ordinary skill in the art.

FIG. 1B shows that there may be additional suspended films (21) to increase the number of inter-pane cavities (23) and the overall insulating properties of the IGU (11). The IGU (11) of FIG. 1B is effectively a quadruple-pane window and, while FIG. 1B has two suspended film sheets (21) and three inter-pane cavities (23), IGUs (11) could be constructed with even more “panes”, such as with three suspended film sheets (21) and thus four inter-pane cavities (23), yielding even greater insulative capabilities of the IGU (11).

As should be apparent from FIGS. 1A and 1B, once the IGU (11) has been assembled, the film(s) (21) are generally inaccessible from outside the IGU (11). Thus, there is generally no way to mechanically tension them after the IGU (11) is constructed. Further, as the ends of the film(s) (21) are often within the sealant (25), if the sealant (25) has not yet cured, attempting to thermally tension the film (21) while curing the sealant (25) could cause the film (21) to pull free of the sealant (25) and collapse into the cavity (23) of the IGU (11).

With reference to FIG. 2, some form of thermal treatment of the assembled IGU (11) is required to tension the film (21). Further, thermal treatment is also often desired to speed up the curing of the polyurethane or silicone sealant (25) so that it reaches the required structural strength within a reasonable manufacturing time frame. Polyurethane and silicone sealants (25) generally cure faster at elevated temperatures within a range determined by the specific sealant chemistry. Thus, selecting a temperature in that range often provides improved efficiency to the process.

The tensioning of the PET film (21) generally occurs in the vicinity of 100° C., and it is important that the amount of tensioning be properly controlled. If the tensioning occurs too quickly, or too high a temperature is applied, the film (21) can tear, melt, or otherwise become damaged. As discussed above, since the film (21) is generally inaccessible inside the IGU (11) at the time it is thermally tensioned, such damage is generally not easily repairable and can result in the loss of an entire IGU (11). Finally, it is generally necessary to reduce the temperature of the IGU (11) in a controlled fashion after the tensioning is complete to prevent damage to the glass panes (13) and (15) of the IGU (11) from rapid cooling.

An embodiment of a temperature-time profile of the heat treatment of an IGU (11) is shown in FIG. 2. This profile provides that the sealant (25) is first cured at a lower temperature. Specifically, the curing occurs at a temperature generally below the thermal shrinking temperature of the film (21). In an embodiment, this first temperature level or plateau is preferably less than 80° C., less than 75° C., or around 50° C. for a polyurethane or silicone sealant and a PET film. Once the sealant (25) is sufficiently cured, the temperature of the IGU (11) is raised to provide for tensioning and heat shrinking of the PET film (21). This second temperature level or plateau is preferably at least 80° C. and will often be around 100° C. Once the tensioning is completed, the IGU (11) is allowed to cool back to ambient temperature.

It should be recognized that ambient temperature is dependent on a variety of factors and can be a relatively wide range of values. However, it is generally accepted that temperatures from around 15° C. to about 25° C. are common ambient temperatures in most scenarios and a temperature of 20° C. is often used to indicate the ambient temperature. Cooling may be accomplished simply by allowing the IGU (11) to rest at ambient temperature, to slowly reduce temperature, or a temperature below ambient may be provided to accelerate cooling to ambient temperature.

In FIG. 2, the steps of heating the IGU (11) are performed sequentially in the following fashion. First, the temperature of the IGU (11) is raised (step 30) to a first elevated elevated temperature of at least about 40° C. to a maximum of about 60° C. and preferably to about 50° C.±2° C. The IGU (11) is then maintained at this first elevated temperature for a duration of at least an hour and preferably for about 65 to about 80 minutes (step 31). Second, the IGU (11) temperature is further raised without allowing the IGU (11) to cool between steps. The temperature is generally raised to a second elevated elevated temperature of at least about 80° C. and at most about 110° C. and preferably about 100° C.±2° C. (step 32). The IGU (11) is held at this second elevated temperature for a specified duration of from about 20 to about 55 minutes (step 33). Once the thermal tensioning time for the suspended film (21) has passed and the tensioning is complete, the IGU (11) is preferably cooled (step 34) back down to ambient temperature. This will often occur within a time of about 15 to about 30 minutes. The total elapsed time for the multi-stage thermal treatment of this embodiment of FIG. 2 is therefore generally around 2 to 2½ hours, which is acceptable in most manufacturing scenarios.

It should be recognized that the temperatures and times used in the above embodiments are for IGUs (11) utilizing polyurethane sealant (25) and PET film (21). If other sealants (25) or suspended film (21) polymers are used, the temperatures and/or times may be adjusted, as would be understood by one of ordinary skill, to obtain the required sealant (25) strength in a desired time frame and the specified tensioning of the suspended film (21) for wrinkle removal within that film (21) material's structural limits.

In order to efficiently implement the above heating process of FIG. 2, a heating system such as a convection oven, and preferably a forced-air re-circulating industrial heating oven, can be used. The heating of the re-circulating air may be accomplished by any method or means known to one of ordinary skill in the art, but is commonly accomplished by gas or electrical heating. The heating system preferably provides the following to the IGU (11), in order. An IGU (11) at ambient temperature is first is raised to a first elevated temperature that is sufficient to cure the sealant (25), but insufficient to thermally shrink the film (21) and that first temperature needs to be maintained for a first time duration. This generally means a temperature of less than 80° C. The IGU (11) then needs to be raised to a second elevated temperature and maintained at that temperature for a sufficient time duration to thermally shrink the film (21). This is generally a temperature above 80° C. Finally, the IGU (11) needs to be cooled back to ambient temperature in a manner to ensure no cooling related damage. Because multiple IGUs (11) need to be thermally treated in a manufacturing setting and the IGUs (11) are generally continually in various stages of assembly and readiness for processing, the thermal treatment is preferably conducted in a continuous process.

One embodiment of a system for providing a continuous thermal treating process utilizing the parameters of FIG. 2 is shown in FIG. 3. In FIG. 3, a tunnel oven (41) is provided that comprises a series of oven sections (43A), (43B), (43C), (43D), and (43E). These sections are preferably separated by gates to maintain individual heating areas. However, in an alternative embodiment, the temperature differentials may be maintained by using the transition sections (43A), (43C) and (43E) as “buffer” zones. In these buffer zones, warmer air from a hotter section and cooler air from the other section are allowed to intermix. This mixed air may have a number of discrete temperature zones, or shifting temperature gradients, but serves to act as a thermal barrier maintaining the adjacent maintenance zones (43B) and (43D) at a generally consistent temperature.

Generally, there is at least one section (43A), (43B), (43C), (43D), and (43E) dedicated to each of the curing, tensioning/shrinking, and cooling steps of the IGUs' (11) treatment. However, in an embodiment, the sections have some overlap in the functions they perform. For example, the tensioning section could also perform additional cure on the sealant (25). The length of each section may be determined by the specified treatment time for each step, where a conveyer (not shown) within the tunnel causes IGUs (11) to progress at a constant speed through the tunnel oven (41). While the specific speed may be selected based on speed and space requirements, in an embodiment the speed comprises about 20 cm/min. In that case, a length of 3 meters would correspond to 15 minutes of treatment time, while a length of 12 meters would correspond to a treatment duration of one hour. As the embodiment of FIG. 2 contemplates a total treatment time of around two to two-and-a-half hours, this would provide a tunnel arrangement from about 24 to about 30 meters which is easily positioned in most modern manufacturing buildings.

In the embodiment of FIG. 3, the tunnel oven (41) includes a loading lobby (45) which allows for IGUs (11) to be loaded at generally ambient temperature. This prevents workers from having to be exposed to elevated temperatures and/or isolates the raised temperature in the oven from the rest of the manufacturing process to prevent heat escape and premature heat exposure by an IGU (11). After the IGUs (11) are loaded in the loading lobby (45), they generally proceed into a first section (43A) at a first temperature that preheats IGUs (11) to about the first elevated temperature.

In the embodiment of FIG. 3 implementing the method of FIG. 2, the IGUs (11) are heated from about to 20° C. to about 50° C. In an embodiment, the first section (43A) will generally provide heat at around the first elevated temperature (e.g., 50° C.) with the time the IGU (11) spends in the first section (43A) corresponding to the amount of time it takes the temperature of the IGU (11) to equalize with its surroundings. However, it should be noted that, since the section (43A) is used for raising the temperature of the IGU (11) to the first elevated temperature, in an alternative embodiment the section (43A) may be hotter than the first elevated temperature so that the temperature of the IGU (11) itself is approaching the first elevated temperature as the IGU (11) is exiting the section (43A). This embodiment can accelerate the heating to the IGU (11) allowing for the section (43A) to be shorter.

Once the IGU (11) has been raised to the target first elevated temperature, the IGU (11) will pass into a second section (43B) that holds the IGUs (11) at that first elevated temperature for a time sufficient for curing the sealant (25). The sections (43A) and (43B) may have respective lengths/durations corresponding to about 15 and about 65 minutes respectively, for a total duration of between about 65 and about 80 minutes of sealant cure. In the event that time is more limited or the oven needs to be shorter, duration in the sections (43A) and/or (43B) may be shortened and the temperature increased. In a still further embodiment, the IGU (11) may leave the section (43B) before the sealant (25) is completely cured. In such a scenario, the transition section (43C) may be used to provide a final amount of cure even as the IGUs' temperature is being raised to provide for thermal shrinking of the film (21).

At the end of the section (43B), the IGU (11) will generally pass into a third section (43C) which is substantially hotter than the section (43B) and that serves to preheat the IGUs (11) from the first plateau to the second elevated temperature. A gate may separate the sections (43B) and (43C) if desired. In FIG. 2, the second elevated temperature is about 100° C. As with the first transition section (43A), the second transition section (43C) may provide heat at the target second elevated temperature, or may be heated above the second elevated temperature so that the IGU (11), after passing through the section (43C), is at about the second elevated temperature. Again, the time and temperature of the section (43C) will often be selected based on available space and time.

Once the IGU (11) is at the second elevated temperature, the IGU (11) enters the fourth section (43D) that holds the IGUs at the second elevated temperature for tensioning the suspended film(s) (21). Sections (43C) and (43D) may have respective lengths/durations corresponding to about 35 and 20 minutes respectively for a total thermal shrinking time duration of about 20 to about 55 minutes.

As the IGU (11) is approaching the end of the section (43D), it will generally be considered finished and may pass through a gate into the section (43E) that cools the IGUs (11) from the second elevated temperature to the ambient temperature. In an embodiment, the section (43E) maybe a transition section with the section (47) simply being at ambient temperature and the section (43E) providing a gradient cooling based on heat leakage from the section (43D). The cool down may have a length/duration corresponding to about 15 to about 30 minutes. In the section (43E), the IGU may be exposed to a reduced heat to allow it to cool slower or may simply be placed in ambient air, allowing a quicker cool. While it is generally considered undesirable, the section (43E) may alternatively provide for a cooling effect (e.g., through the use of fans blowing in cooler ambient air or from cooling jets) below ambient temperature to cool the IGU (11) faster.

Once the IGU (11) is sufficiently cooled, it will enter into an exit lobby (47) adjacent to the cooler section (43E) allowing for removal of the IGU (11) from the tunnel oven (41) for transfer of the IGU (11) to further treatment areas. This can include a gas fill station for placing gases in cavities (23), inspection stations, or other portions of the assembly facility.

While the invention has been described with reference to exemplary embodiments, it will be understood by those skilled in the art that various changes may be made and equivalents may be substituted for elements thereof without departing from the scope of the invention. Specifically, temperatures given herein are directed to specific sealant (25) and film (21) compositions as well as to tunnel oven systems (41) having a particular time and length of their operation. Thus, temperatures and durations may vary, depending on the desired cure time and resulting sealant (25) strength, on the desired amount of film (21) tensioning, on available space and time requirements of the facility, and on the specific material compositions of the components of the IGU (11). However, the amounts given herein are acceptable for an embodiment of the IGU (11) using for polyurethane sealant (25) and PET film (21) with glass outer panes (13) and (15).

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A method of treating an insulating glass unit having a suspended film therein, comprising:
providing an insulating glass unit having a suspended film therein and a sealant thereon;
raising a temperature of said glass unit to a first elevated temperature above an ambient temperature;
maintaining said glass unit at said first elevated temperature for a sufficient time to cure said sealant;
raising a temperature of said glass unit to a second elevated temperature above said first elevated temperature;
maintaining said glass unit at said second elevated temperature for sufficient time to thermally shrink said suspended film to a point of being optically clear; and
cooling the insulating glass unit to said ambient temperature.

2. The method of claim 1, wherein the curing, shrinking and cooling take place within a tunnel oven having at least three distinct temperature zones.

3. The method of claim 2, wherein said at least three distinct sections are separated by gates, and at least one of said at least three sections is maintained at said first elevated temperature and at least one of said at least three sections is maintained at said second elevated temperature.

4. The method of claim 3, wherein the tunnel oven includes a first section that preheats an insulating glass unit to the first elevated temperature, a second section that holds the insulting glass unit at the first elevated temperature, a third section that preheats the insulating glass unit from the first to the second elevated temperature, a fourth section that holds the insulating glass unit at the second elevated temperature, and a fifth section that cools the insulating glass unit to the ambient temperature.

5. The method of claim 1, wherein the sealant comprises at least one sealant selected from the group consisting of: polyurethane sealant, silicone sealant, and polysulfide sealant.

6. The method of claim 1, wherein the first elevated temperature is in a range from about 40° C. to about 60° C. and the specified first duration is about 65 to about 80 minutes.

7. The method of claim 1, wherein the suspended film is a polyethylene terephthalate (PET) film.

8. The method of claim 1, wherein the second elevated temperature is in a range from about 90° C. to about 110° C. and the specified second duration is about 20 to about 55 minutes.

9. The method of claim 1, wherein the cooling to ambient temperature occurs over a specified third duration of about 15 to about 30 minutes.

10. The method of claim 1, wherein said insulating glass unit is moved continuously through the steps of the method by a conveyor.

11. A tunnel oven, comprising:
a conveyor for transporting an insulating glass unit having a suspended film therein and a sealant thereon;
a loading lobby for placing an insulating glass unit on said conveyor; said conveyor transporting said insulating glass unit through:
a first section for raising a temperature of said glass unit to a first elevated temperature above an ambient temperature;
a second section for maintaining said glass unit at said first elevated temperature for a sufficient time to cure said sealant;
a third section for raising a temperature of said glass unit to a second elevated temperature above said first elevated temperature;
a fourth section for maintaining said glass unit at said second elevated temperature for sufficient time to thermally shrink said suspended film to a point of being reflectively flat;
a fifth section for cooling the insulating glass unit to said ambient temperature; and
an exit lobby for removing said insulating glass unit from said conveyor.

12. The tunnel oven of claim 11 wherein:
said second section is separated from said third section by a gate; and
said fourth section is separated from said fifth section by a gate.

13. The tunnel oven of claim 11 wherein;
a temperature in said first section and a temperature in said third section are established by heat moving into said first section and said third section from said second section.

14. The tunnel oven of claim 13 wherein said temperature in said third section is also established by heat moving into said third section from said fourth section.

15. The tunnel oven of claim 11 wherein said tunnel oven is about 24 to about 30 meters long

16. The tunnel oven of claim 11 wherein said insulating glass unit resides in said tunnel oven for about 2 to about 2.5 hours.

17. The tunnel oven of claim 16 wherein said insulating glass unit resides in some combination of said first section and said second section for about 65 to about 80 minutes.

18. The tunnel oven of claim 17 wherein said insulating glass unit resides in some combination of said third section and said fourth section for about 20 to about 55 minutes.

19. The tunnel oven of claim 18 wherein said insulating glass unit resides in said fifth section for about 15 to about 30 minutes.
